(19) United States
(12) Patent Application Publication
(10) Pub. No.: US 2017/0163565 A1
(43) Pub. Date: Jun. 8, 2017

(54) SYSTEM FOR ANALYSIS OF RESOURCE USAGE AND AVAILABILITY

(71) Applicant: BANK OF AMERICA CORPORATION, Charlotte, NC (US)

(72) Inventor: William Louis Moran, JR., Montclair, NJ (US)

(21) Appl. No.: 14/959,704

(22) Filed: Dec. 4, 2015

(51) Int. Cl. H04L 12/911; G06F 17/30

(52) U.S. Cl. CPC H04L 47/823; G06F 17/30569; G06F 17/30294; G06F 17/30339; H04L 47/822

(57) ABSTRACT

Systems, computer products, and methods are described herein for allowing users to create and control reports that are utilized to determine usage and availability of resources for the organization or for units within the organization and/or to illustrate the usage and availability of resources to industries, sectors, clients, vendors, positions, projects, and/or the like. The report illustrates how the organization is using resources and/or the resources that are available to the organization, and to report resource usage and/or availability for forecasting for strategic planning and/or for regulatory compliance. It should be understood that the present invention may be utilized for any type of resource of an organization to illustrate resource usage and availability.

### FIELD

The present invention relates to utilizing centralized creation and control for identifying the usage and availability of resources within an organization across the units of the organization in order to improve allocation of resources, as well as for reporting for regulatory compliance and forecasting.

### BACKGROUND

Determining the resources that are in use and the resources that are available to an organization may prove difficult due to the changing environment in which resources may be allocated, used, made available, changed, or the like. Moreover, regulatory compliance requires improvements on how the resources are monitored and tracked in order to comply with reporting for regulatory compliance that may also change over time.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Generally, systems, computer products, and methods are described herein for allowing users to create and control reports that are utilized to determine usage and availability of resources for the organization or for units within the organization and/or to illustrate the usage and availability of resources to industries, sectors, clients, vendors, positions, projects, and/or the like. The report illustrates how the organization is using resources and/or the resources that are available to the organization, and to report resource usage and/or availability for forecasting for strategic planning and/or for regulatory compliance. The reports may be related the actual usage and availability of resources, and/or may be estimated usage and availability of resources based on one test scenarios. The usages and availability of resources may be determined through a network of interconnected systems that allows users to access, create, and control the transformation of data (e.g., resource and reference data as described later) into the desired formats for reporting as necessary. One embodiment of the invention includes identifying the capital management of the organization for regulatory responsibility. Moreover, one embodiment may also provide an improved view of an organization's capital usage and availability, which is likely to result in improved usage of capital, which is likely to result in increased available capital. The present invention may be further utilized to create forecasting based on the current usage and availability of resources, but may also be utilized to create various scenarios and testing of the results of the scenarios. It should be understood that the present invention may be utilized for any type of resource of an organization to illustrate resource usage and availability, and examples provided with respect to capital resource management are provided as one illustrative embodiment.

Embodiments of the invention comprise systems, computer implemented methods, and computer program products for monitoring and analyzing resource usage and availability for providing reports regarding the resource usage and availability. The invention comprises receiving a request from a user to create a report for the resource usage and availability for an activity, wherein the report is created by the user by utilizing a logical data model and a schema. The invention further comprises receiving a request from the user to utilize a reference data manger application to select the reference data utilized to create the report, wherein the reference data includes standardized data used by calculations to transform resource data for the reports. The invention comprises receiving a request from the user to utilize a manual adjustment application to adjust the resource data, wherein the resource data includes the data for forecasting, for scenarios, or for compliance regarding the resource usage and availability. The invention further comprises receiving a request from the user to access a command and control center application to monitor reports, wherein the user may start, stop, or check the status of the reports being run. The invention comprises receiving a request from the user to run the report. The invention further comprises utilizing the logical data model and the schema, the reference data, and the resource data to transform the reference data and the resource data to create the report, and provide the report to the user regarding the activity on a user computer system.

In further accord with an embodiment of the invention, the logical data model comprises logical object tables and logical hierarchies, wherein the logical object tables correspond to physical stored tables of resource data or reference data, and wherein the logical hierarchies group attributes in the tables to reflect relationships and provide convenient drilling paths for the report.

In another embodiment of the invention, the logical data model comprises the attributes, facts, and transformations; wherein the attributes represent qualitative information, provide context, and define the aggregation level of calculations on the report; wherein the facts are quantitative information displayed on the report, and are determined from one or more fields in the resource data; and the transformations allow the user to apply an attribute offset for fact comparison purposes.

In yet another embodiment of the invention, the schema comprises a map to the resource data or the reference data.

In still another embodiment of the invention, the report is further based on a template providing a structure of how the report will be presented, wherein the template is populated with report objects including the attributes, metrics, and filters; wherein the attributes represent qualitative information, provide context, and define the aggregation level of calculations on the report; wherein the metrics include numbers that the user wants to include in the report and are associated with the attributes; and the filters include view filters and report filters.

In further accord with an embodiment of the invention, the manual adjustment application is used by the user to adjust resource data using a structured query language (SQL) query or a comma separated value (CSV) file.

In another embodiment, the invention further comprises receiving a request from the user to utilize a submission framework to add additional data to the resource data, and wherein the report is further based on the additional data added to the resource data.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, and wherein:

FIG. 1 illustrates a block system diagram of a resource analysis system environment, in accordance with embodiments of the invention.

FIG. 2 illustrates a flow of the data through the resource analysis system environment, in accordance with embodiments of the invention.

FIG. 3 illustrates a process flow for using the resource analysis system environment to determine the usage and availability of resources, in accordance with embodiments of the invention.

FIG. 4 illustrates a reference data manager interface for managing reference data, in accordance with embodiments of the invention.

FIG. 5 illustrates a manual adjustment interface for adjusting the resource data before being used in reporting, in accordance with embodiments of the invention.

FIG. 6 illustrates a manual adjustment interface for adjusting the source data before being used in reporting, in accordance with embodiments of the invention.

FIG. 7 illustrates a command and control interface for running and monitoring data movement and calculation processes that create the source data for reporting, in accordance with embodiments of the invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

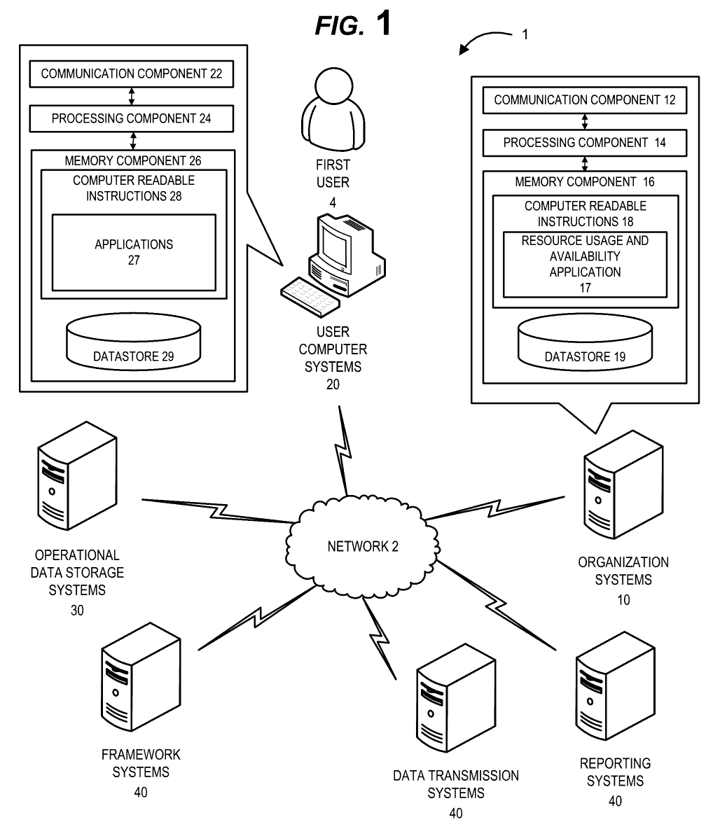

Systems, methods, and computer program products are herein disclosed that provide for determining the usage and availability of resources throughout an organization. FIG. 1 illustrates an organization resource analysis system environment 1, in accordance with embodiments of the invention. As illustrated in FIG. 1, one or more organization systems 10 are operatively coupled, via a network 2, to one or more user computer systems 20, one or more data storage systems 30, one or more framework systems 40, one or more data transmission systems 50, and one or more reporting systems 60, or the like. In this way, the user 4 (e.g., one or more associates, employees, agents, contractors, sub-contractors, third-party representatives, or the like) may determine the organization's resource usage and availability by accessing the resource usage and availability application 17 through the organization systems 10 and/or other systems within the resource analysis system environment 1. The resource usage and availability application 17 allows the user 4 to create and control reports that are utilized to determine usage and availability of resources for the organization or for units within the organization and/or to illustrate the usage and availability of resources to industries, sectors, clients, positions, projects, and/or the like (collectively “activities”). The determination illustrates how the organization is using resources and/or the resources that are available to the organization, and to report resource usage and/or availability for forecasting for strategic planning and/or for regulatory compliance.

As such, the users 4 may utilize the resource usage and availability application 17 to take actions and/or to communicate with (e.g., send or receive data from, control, or the like) the applications and the components (e.g., devices, or the like) within the resource analysis system environment 1. The resource usage and availability application 17 may utilize the network 2 to communicate with applications 27 on the user computer systems 20, data storage systems 30, framework systems 40, data transmission systems 50, reporting systems 60, and/or other systems. In some embodiments of the invention the resource usage and availability application 17 may allow the user to provide, store, receive, transform, manipulate, or the like, the data in order to identify the resource usage and availability for the organization and/or the organization's units.

The network 2 may be a global area network (GAN), such as the Internet, a wide area network (WAN), a local area network (LAN), or any other type of network or combination of networks. The network 2 may provide for wireline, wireless, or a combination of wireline and wireless communication between systems, services, components, and/or devices on the network 2.

As illustrated in FIG. 1, the organization systems 10 generally comprise one or more communication components 12, one or more processing components 14, and one or more memory components 16. The one or more processing components 14 are operatively coupled to the one or more communication components 12 and the one or more memory components 16. As used herein, the term “processing component” generally includes circuitry used for implementing the communication and/or logic functions of a particular system. For example, a processing component 14 may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more processing components 14 may include functionality to operate one or more software programs based on computer-readable instructions 18 thereof, which may be stored in the one or more memory components 16.

The one or more processing components 14 use the one or more communication components 12 to communicate with the network 2 and other components on the network 2, such as, but not limited to, the user computer systems 20, the data storage systems 30, framework systems 40, data transmission systems 50, reporting systems 60, or other systems. As such, the one or more communication components 12 generally comprise a wireless transceiver, modem, server, electrical connection, electrical circuit, or other component for communicating with other components on the network 2. The one or more communication components 12 may further include an interface that accepts one or more network interface cards, ports for connection of network components, Universal Serial Bus (USB) connectors and the like.

As further illustrated in FIG. 1, the organization systems 10 comprise computer-readable instructions 18 stored in the memory component 16, which in one embodiment includes the computer-readable instructions 18 of the resource usage and availability application 17. In some embodiments, the one or more memory components 16 include one or more data stores 19 for storing data related to the organization systems 10, including, but not limited to, data created, accessed, and/or used by the resource usage and availability application 17.

As illustrated in FIG. 1, users 4 may access the resource usage and availability application 17, or other applications, through a user computer system 20. The user computer system 20 may be a desktop, laptop, tablet, mobile device (e.g., smartphone device, or other mobile device), or any other type of computer that generally comprises one or more communication components 22, one or more processing components 24, and one or more memory components 26.

The one or more processing components 24 are operatively coupled to the one or more communication components 22, and the one or more memory components 26. The one or more processing components 24 use the one or more communication components 22 to communicate with the network 2 and other components on the network 2, such as, but not limited to, the organization systems 10, the data storage systems 30, the framework systems 40, the data transmission systems 50, the reporting systems 60, and/or other systems. As such, the one or more communication components 22 generally comprise a wireless transceiver, modem, server, electrical connection, or other component for communicating with other components on the network 2. The one or more communication components 12 may further include an interface that accepts one or more network interface cards, ports for connection of network components, Universal Serial Bus (USB) connectors and the like. Moreover, the one or more communication components 22 may include a keypad, keyboard, touch-screen, touchpad, microphone, mouse, joystick, other pointer component, button, soft key, and/or other input/output component(s) for communicating with the users 4.

As illustrated in FIG. 1, the user computer systems 20 may have computer-readable instructions 28 stored in the one or more memory components 26, which in one embodiment includes the computer-readable instructions 28 of applications 27, such as dedicated applications (e.g., apps, applet, or the like), portions of dedicated applications, web browser or other apps that allow access to applications located on other systems, or the like.

As illustrated in FIG. 1, the data storage systems 30, the framework systems 40, the data transmission systems 50, the reporting systems 60, and/or other like systems are operatively coupled to the organization systems 10 and/or user computer systems 20, through the network 2. The data storage systems 30, the framework systems 40, the data transmission systems 50, the reporting systems 60, and/or other like systems have components the same as or similar to the components described with respect to the organization systems 10 and/or user computer systems 20 (e.g., one or more communication components, one or more processing components, and one or more memory devices with computer-readable instructions of one or more applications, one or more datastores, or the like). Thus, the data storage systems 30, the framework systems 40, the data transmission systems 50, the reporting systems 60, and/or other like systems communicate with the organizational systems 10, the user computer systems 20, and/or each other in same or similar way as previously described with respect to the organization systems 10 and/or the user computer systems 20.

The data storage systems 30, and associated data storage application(s), such as database applications, are used for the data storage for the resource data and the reference data, the input data for staging, transformation data, and/or calculation data. The data storage systems 30 may further include storage for the data used for reporting the resource usage and availability of the organization and/or units within the organization, or other activities discussed herein.

The framework systems 40, and associated framework application(s), are used to house the calculator code and user interfaces for the resource usage and availability application 17 and associated applications. The framework systems 40 may include various user interface applications that are utilized by the resource usage and availability application 17 to provide the resource usage and availability functions described herein. For example, the framework applications may include a command center application, a manual adjustment application, reference data manager application, and/or data submission application. It should be understood that these applications may be separate applications, or one or more portions of one or more applications, such as components of the resource usage and availability application 17. The command center application provides a single source of execution and monitoring for the resource usage and availability application 17 run time processes and tasks, and execution logging in order to create the reports. The framework applications may further include a manual adjustment application, which provides users 4 of the resource usage and availability application 17 a means to examine and analyze the data (e.g., resource usage and availability data) upon which the calculators operate and apply compensatory updates as appropriate. The manual adjustment application provides a means to update incomplete or incorrect data, as well as manage various systemic inaccuracies introduced when large datasets of resource usage and availability are entered, transmitted, and/or stored through the resource usage and availability application 17. The reference data manager application provides access to manage tables containing reference data utilized across all the calculators, and provides versioning and control functions for shared data. The data submission application allows the user to upload additional information to the resource data.

The data transmission systems 50, and associated data transmission applications, are utilized for extracting, transforming, and loading data from various sources into and out of the organization systems 10, data storage systems 30, the framework systems 40, and/or the reporting systems 60.

The reporting systems 60, and associated reporting application(s), are utilized to create the resource usage and availability reports for the units within the organization and for regulatory compliance, as will be discussed in further detail herein.

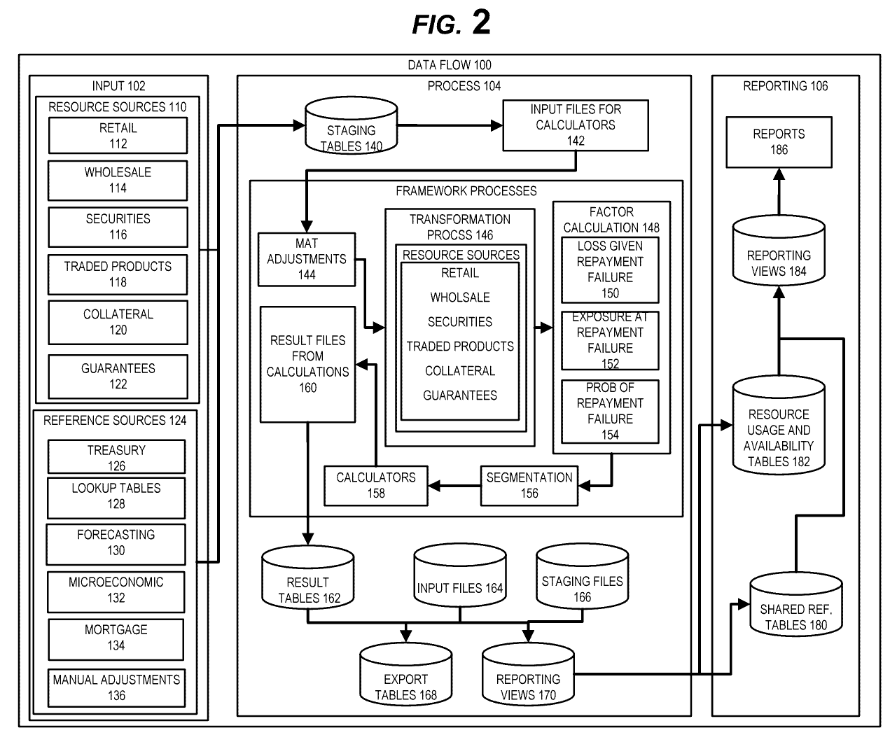

FIG. 2 illustrates an architectural overview 200 of factor creation and resource calculations for determining resource usage and availability of an organization (or a unit, or sub-unit of the organization, or other activity of the business) and how the data flows through the resource analysis system environment 1. FIG. 2 is illustrated with respect to a financial institution, however it should be understood, as previously discussed, that the resource analysis system environment 1 can be utilized with any organization to determine the resource usage and availability for the organization.

As illustrated in FIG. 2 the architecture is broken up into an input section 102, process section 104, and reporting section 108. The input section 102 may include the resource data from various resource sources 110. The resource sources 110, in the illustrated example, may include capital usage and availability from retail 112 operations (e.g. resource usage and availability illustrating exposure to individual and small businesses), wholesale 114 operations (e.g., resource usage and availability illustrating exposure to broker-dealers and large institutions), securities 116 operations (e.g., resource usage and availability illustrating exposure to security positions), traded product 118 operations (e.g., resource usage and availability illustrating exposure to funds), collateral 120 operations (e.g., resource usage and availability illustrating value of collateral to offset exposure), and guarantee 122 operations (e.g., resource usage and availability illustrating third-party payments to offset exposure), and/or other resource sources 110.

The input section 102 may further include reference data from reference sources 124 which may be utilized to determine the usage and availability of resources based on forecasting, scenarios, or the like. The resource data may include the standardized data or other data used by the calculators 158 to transform the resource data into the desired output data (e.g., report data) for the reports. Continuing with the example related to capital resources, the reference sources 124 may include data from a treasury data source 126 (e.g., capital data for the capital calculation process), lookup table sources 128 (e.g., for standardized data), forecasting sources 130 (e.g., financial data including estimated rates of return, or the like), macroeconomic data sources 132 (e.g., data used to determine the probably of repayment failure), mortgage sources 134 (e.g., mortgage exposure), manual adjustment sources 136 (e.g., adjustments to resource data), and/or other sources of data.

The input information, including the resource data and/or the reference data is stored within the data storage systems 30 within staging tables 140. The staging tables 140 are utilized to transform the input data from the resource data and/or the reference data into the organized data for the desired report (e.g., the report the user is requesting as discussed in further detail later), which can be transformed into input files 142 for the calculators to create the reports. The input files 142 may be the files provided to or used by the transformation process 146, the factor calculations 148, and/or the calculators 158 to form the data for the reports through the use of the framework systems 40, reporting systems 60, or other systems. Within the framework systems 40, the input files 142 may be adjusted by adjusting the resource data through the manual adjustment application 144, if necessary. The manual adjustment application, which will be described in further detail later, may be utilized by the user 4 to adjust the input files in order to receive the desired output before the input files are provided for transformation processing 146. The transformation process 146 may include transforming the fields of the data (e.g., table fields, or the like) into the desired configuration for performing the calculations and presenting the various upstream data for the factor calculation 148 and to the calculators 158 in a normalized/standardized format, as needed. After transformation of the input files 142, the resource data is subjected to factor calculation processing 148. With respect to the example of capital management within a financial institution, the factor calculation processing 148 may include determinations of the estimated loss given repayment failure 150, the exposure based on a repayment failure 152, and the probability of repayment failure 154 for capital resources being used. The estimated loss given repayment failure 150 may include, for example, the loss on a loan, loss on an investment, loss of a security position, or the like if a client, user, entity, market fails to make a payment or a loss is otherwise realized. The exposure at repayment failure 152 may include the organizations additional exposure indirectly related to any repayment failure 150 (e.g., associated loans to the same entity, other market positions that may be at risk, or the like). The probability of repayment failure 154 is used to determine the likelihood of the repayment failure occurring. As such, the factor calculation 148 may determine the factors that are utilized to determine the resource usage and availability exposure for the report.

After the factor calculations are determined a segmentation process 156 may be applied to the resource data (e.g., the usage and availability data, including any exposure data). The segmentation may include segmenting the resource data related to the usage and availability, including any associated exposure, to the various sectors, industries, clients, groups, sub-groups, categories, or other like activities as desired by report selected by the user 4 for forecasting and/or for regulatory compliance reporting purposes. For example the capital resources usage and availability may be segmented into the proper lines of business.

After segmentation the resource usage and availability calculators 158 are applied to the resource data. The calculators may include standardized calculators (e.g., calculations required for regulatory reporting, or the like) and/or customized calculators (e.g., proprietary calculators) that are specifically created by the organization in order to transform the resource data and/or reference data into the report data that is incorporated into the requested reports. For example, returning to the example of capital management for a financial institution, the standardized calculators may include capital calculation requirements mandated by regulators (e.g., capital holdings in case of a market issues), while the customized calculators may include forecasting calculations (e.g., rates of return based on investment strategy) or economic capital calculations which are utilized for the determination of strategic capital limits allocated to various of segments, units, or the like of the organization. The output from the calculators 158 may be transformed into result files 160 that can then be used for a number of different purposes, such as ultimately creating the resource usage and availability reports requested by the user 4.

As illustrated in FIG. 2, the results files 160 may be exported to the storage system 30, for storage in result tables 162. The results tables 162, along with the inputs from the input section 102 that are stored in input files 164, and the staging tables stored in staging table files 166, are stored for later viewing and/or use to create export tables stored in export table storage 168 and/or reporting views stored in reporting view files 170.

The reporting system 60 is then utilized to provide the results files 162, the input files 164, and staging files 166 to the various user's as requested for delivery to units within the organization, to regulatory entities for compliance, or the like as desired by the user 4. As such, the result tables 162, input file 164, and/or the staging files 166 may be provided to create the shared reference tables 180 and/or the resource usage and availability table 182. The shared reference tables 180 may be utilized for multiple reports. For example, returning to the capital management example, the shared reference tables 180 may include universal reference data that may be included on multiple reports across various units within the organization. As such, the shared reference tables 180 may be accessed by multiple reports, as necessary. Alternatively, the resource usage and availability tables 182 may include the information that is specific to specific reports requested by the user 4. The resource usage and availability tables may be specific to a requesting organization unit, sub-unit, regulator, or the like, and thus, may be utilized for providing specific information to the reporting views. Returning to the capital management example discussed herein, the resource usage and availability tables may include the organizations capital exposure in securities based on a sector, industry, client, individuals, or the like.

The resource usage and availability tables 182 and the shared reference tables 180 may be used to populate standard template reporting views or customized template reporting views that are stored in, or can be created through the reporting systems 60, as will be discussed in further detail later.

It should be understood, that the systems described herein may be configured to establish a communication link (e.g., electronic link, or the like) with each other in order to accomplish the steps of the processes described herein. The link may be an internal link within the same entity (e.g., within the same financial institution) or a link with the other entity systems. In some embodiments, the one or more systems may be configured for selectively monitoring the resource usage and availability. These feeds of resource usage and availability may be provided via wireless network path portions through the Internet. When the systems are not providing data, transforming data, transmitting the data, and/or creating the reports, the systems need not be transmitting data over the Internet, although it could be. The systems and associated data for each of the systems may be made continuously available, however, continuously available does not necessarily mean that the systems actually continuously generate data, but that a systems are continuously available to perform actions associated with the systems in real-time (i.e., within a few seconds, or the like) of receiving a request for it. In any case, the systems are continuously available to perform actions with respect to the data, in some cases in digitized data in Internet Protocol (IP) packet format. In response to continuously monitoring the real-time data feeds from the various systems, the systems may be configured to update activities associated with the systems, as described herein.

Moreover, it should be understood that the process flows described herein include transforming the data from the different systems (e.g., internally or externally) from the data format of the various systems to a data format associated with the reports for display. There are many ways in which data is converted within the computer environment. This may be seamless, as in the case of upgrading to a newer version of a computer program. Alternatively, the conversion may require processing by the use of a special conversion program, or it may involve a complex process of going through intermediary stages, or involving complex “exporting” and “importing” procedures, which may converting to and from a tab-delimited or comma-separated text file. In some cases, a program may recognize several data file formats at the data input stage and then is also capable of storing the output data in a number of different formats. Such a program may be used to convert a file format. If the source format or target format is not recognized, then at times a third program may be available which permits the conversion to an intermediate format, which can then be reformatted.

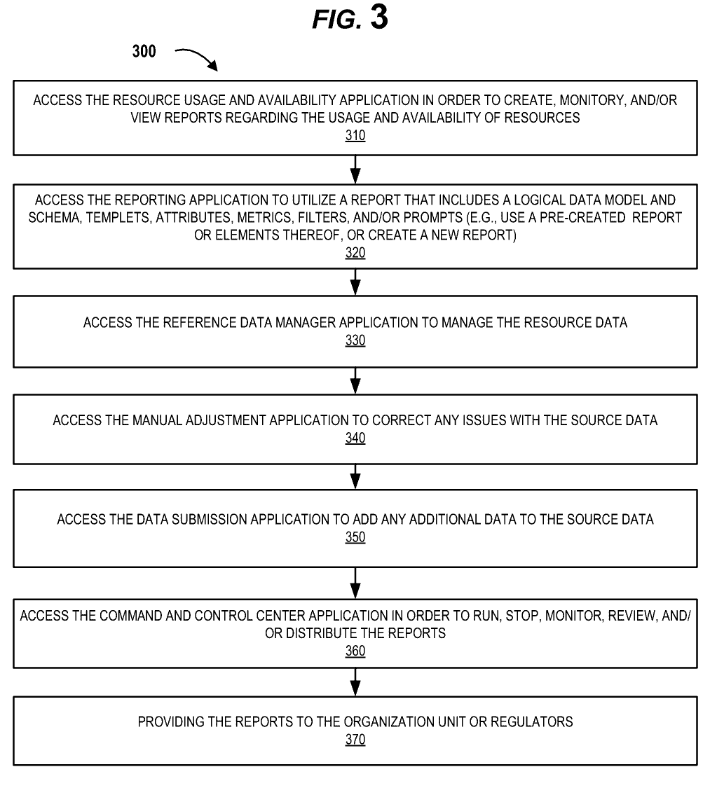

FIG. 3 illustrates a resource usage and availability process flow 300 for utilizing the resource usage and availability application 17, in accordance with one embodiment of the invention. As illustrated in block 310 of FIG. 3 the user 4 may access the resource usage and availability application 17 to create, monitor, control, and distribute the reports regarding resource usage and availability within the organization and/or to regulators.

Block 320 illustrates that the user 4 may access the reporting applications within the reporting system 60 through the resource usage and availability application 17 in order to utilize the desired report. Utilizing the report may include creating the report as will be discussed, and/or selecting portions, or all, of previously created reports. In one embodiments the user 4 may utilize the reporting applications to create the framework for the report and to define the report requirements.

Regardless if the report is a customized one-time report or recurring report the user 4 may begin to create the report by developing a schema and logical data model for the report. The schema includes a detailed representation of the structure of the resource data stored in the database. The logical data model includes logical object tables and logical hierarchies. The logical object tables correspond to the physical stored tables. The logical hierarchies group attributes in the tables to reflect relationships and provide convenient drilling paths for reporting. The logical data model shows the attributes associated with the resource data, and the schema shows how the resource data for the logical data model is stored in the database (e.g., in the data store systems 30). The schema at least includes a map to the columns in the resource data tables. The schema bridges the reporting environment to the resource data. The schema and logical data model includes attributes, facts, hierarchies, and transformations. The attributes represent qualitative information, provide context, and define the aggregation level of calculations on a report. The facts are quantitative information displayed on a report, and are determined from one or more fields in resource data. The transformations allow the user 4 to apply an attribute offset for fact comparison purposes.

Once the schema and logical data model are created the user 4 creates the desired report, which includes the templates and report objects for the templates. The templates include the structure of how the report will be presented. The report objects created by the user 4 includes a request for a specific set of formatted data from the resource data and/or the reference data. The report objects include the attributes (described above), metrics, filters, and prompts. The metrics include the numbers that the user 4 wants to include in the report and are associated with the attributes. The metrics may be pulled from the resource data, or may be derived within the report based on the metrics from the resource data (e.g., calculated metrics based on the metrics in the resource data, or the like). The filters include view filters and report filters. The view filters restrict how much data is retrieved from the resource data without re-executing the report against the resource data, which improves response time and decreases data load. The report filters return the set of report data from the resource data, which the view filter then further restricts for display in the reports. The prompts include all of the objects required to create the report. The template may be set up to include a grid, which displays the report in a cross-tabular display, and/or in a graph, which displays the report in a graphical representation. When the user 4 accesses the reporting applications, the user 4 may select a report (e.g., template, or the other parts of the report) that has already been created, or may design the report (e.g., template and other parts described herein) for the report based on the needs of the user 4 as described herein.

The reporting application that is utilize by the user 4 to create the report utilizes metadata. The metadata contains the information that enables the reporting application to retrieve and display the resource data, reference data, and/or the report data (e.g., the data ultimately displayed in the report). The metadata stores object definitions and maps objects to the data source structures and content therein. The reporting applications use the metadata to translate user request into queries and to translate the results of the quarries back into application objects for the reports, including any associated documents and/or dashboards. The metadata also stores the definitions of all the objects created within the application (e.g., filters, templates, metrics, facts, or the like described herein). The metadata enables the sharing of objects across applications by providing a central repository for all object definitions. All of the interfaces share the same metadata, and thus users 4 can move from one interface to another without any re-configuring or administrator intervention. A report created utilizing the reporting applications can be viewed in any type of operating system on any type of device without any loss of functionality, security, or object privilege settings.

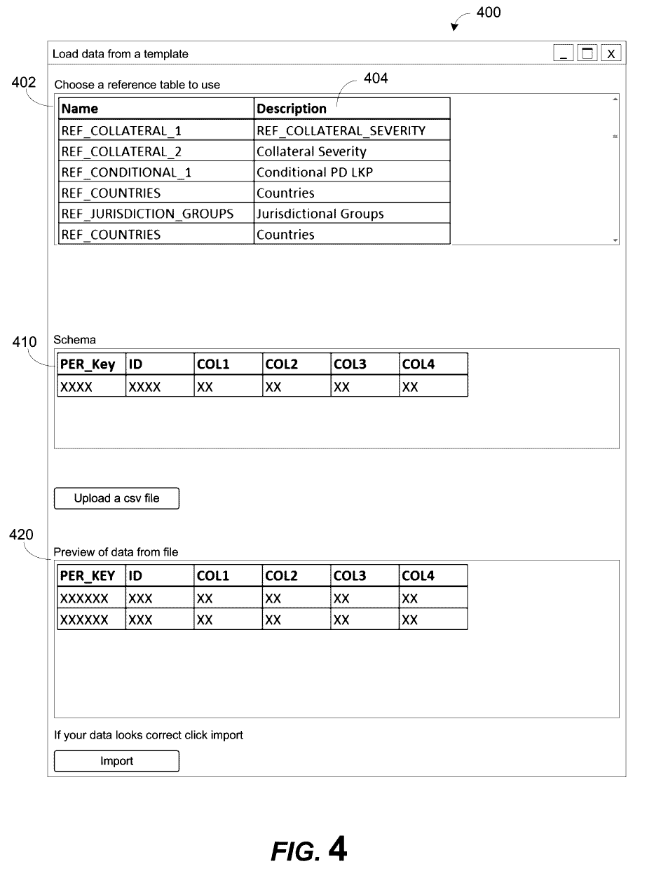

As illustrated by block 330 in FIG. 3, the user 4 may access the reference data manager through a reference data manager interface. FIG. 4 illustrates one embodiment of the reference data manager interface 400. The reference data includes the standardized data used by calculators 158 in order to create the reports. The reference data manager allows the user 4 to access and manage the reference data used by the calculators 158. The reference data may be captured directly from a reference data database or from reference data tables. The reference data manager interface 400 provides a listing of the reference data stored (e.g., stored in the data storage systems 30, or the like). The listing may include a reference data name 402 and an associated reference data description 404 defining for what purpose the reference data is used, as illustrated in FIG. 4. The user 4 may select the reference data to load from the list in the reference data manger interface 400. As previously discussed the reference data may be loaded from a database or from a template, which may have been created by the user 4 or through the reporting application, or other application described herein. When the reference data is loaded from a template, the reference data manager interface 400 may provide the schema associated with the template, as illustrated in one embodiment in the schema section 410 of the reference data manger interface 400. The reference data manger interface 400 may also provide a preview viewer section 420 illustrating the reference data selected before the user 4 imports the entire table. The reference data imported is displayed to the user 4, and the user may edit the data, as necessary. For example, the user 4 may sort, filter, edit the table cells, delete the data, copy the data, paste data, and save/export the data. A comparison between the different sets of reference data may also be presented to the user 4, for example, in order to determine changes in the reference data or differences between reference data in different tables.

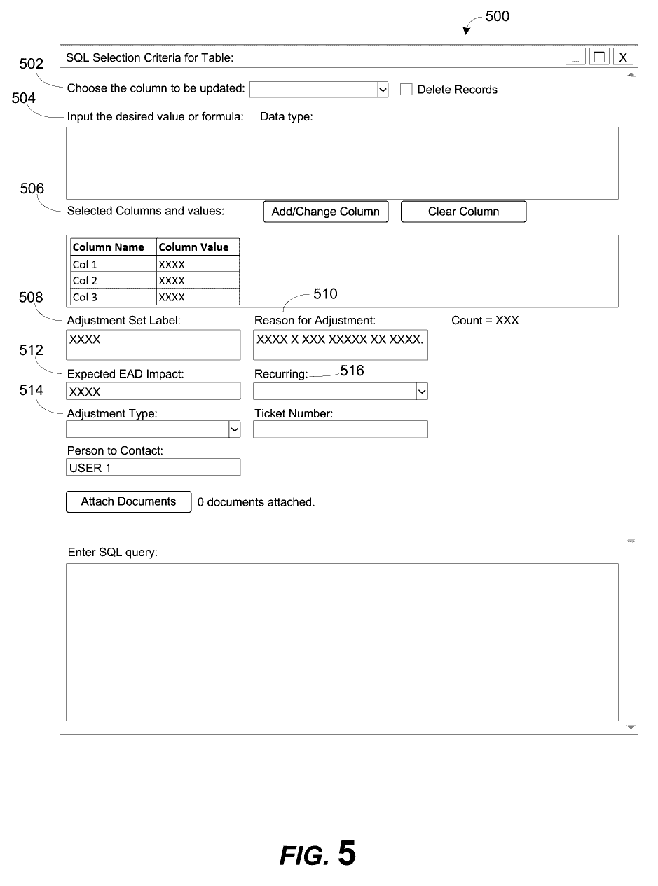

Block 340 in FIG. 3 illustrates that the user 4 may access the manual adjustment tool for correcting issues with the underlying resource data that is used by the calculators 158 and other processes. The resource data includes the resource usage and availability data that is used to create the report. In the example discussed herein, resource data may include the capital and capital exposure an organization may have with clients, to projects, within a particular position, available for capital improvements, or the like. FIG. 5 illustrates one embodiment of a manual adjustment interface 500, which is utilized by a user 4 to create adjustment sets, which can then be applied by downstream processes to make changes to the original resource data. Continuing with the example the user 4 may make changes to the capital management data that is stored as the resource data. It should be understood that the manual adjustment interface 500 does not allow for editing of the key attributes or elements (e.g., groups of attributes) of the resource data (e.g., the identification numbers, start and stop times, or other like elements in the data that can be used to identify the appropriate resource data, or the like) in the tables, and instead uses the key attributes or elements of the resource data to identify the appropriate metrics or other data in the resource data so that the appropriate data can be modified.

The user may utilize the manual adjustment application manage, utilize, create, edit, delete, copy, or the like the manual adjustment sets. For example, the user may utilize (e.g., apply to the resource data) adjustments that other users have created in order to apply the same adjustments to the user's reports. In other embodiments the user 4 may turn off one adjustment and apply a different adjustment to the same set of data, in order to alter the same report with different adjustments to the resource data. In other embodiments, the user 4 may create a new adjustment set, as will be described in further detail below.

The manual adjustment application may be utilized in two different ways to create new adjustment set or to edit adjustment sets already created. One way to adjust the resource data is based on a structured query language (SQL) query as illustrated in the SQL query interface 500. The second way is to create and upload a comma separated value (CSV) file that contains the keys of the record that is being updated as illustrated in the CSV interface 600, described in further detail below. With respect to adjusting the resource data based on an SQL query interface 500, the user 4 may select one or more columns within the resource data to adjust, through the column selection feature 502 and add the new column value in the value input section 504, which may be repeated for all of the columns that the user 4 would like to change. The selected column and value section 506 will illustrate all of the changes entered. The user 4 may also add an adjustment label in the adjustment label section 508, and a reason for the adjustment in the adjustment reasons section 510 to provide a name and description for the adjustment set. The user 4 may further include the expected impact the adjustment will create, as illustrated in the adjustment impact section 512, the adjustment type as illustrated in the adjustment type section 514, and whether or not the adjustment to the resource data is recurring in the adjustment recurring section 516. The interface may further include a contact person for directing questions related to the adjustment set, an identification number associated with adjustment set, and/or an attach document section for attaching documents related to the adjustment. The documents to attach may include information associated with resource data, how to make the adjustments, the information required to run the SQL query, the code used to run the query, or the like.

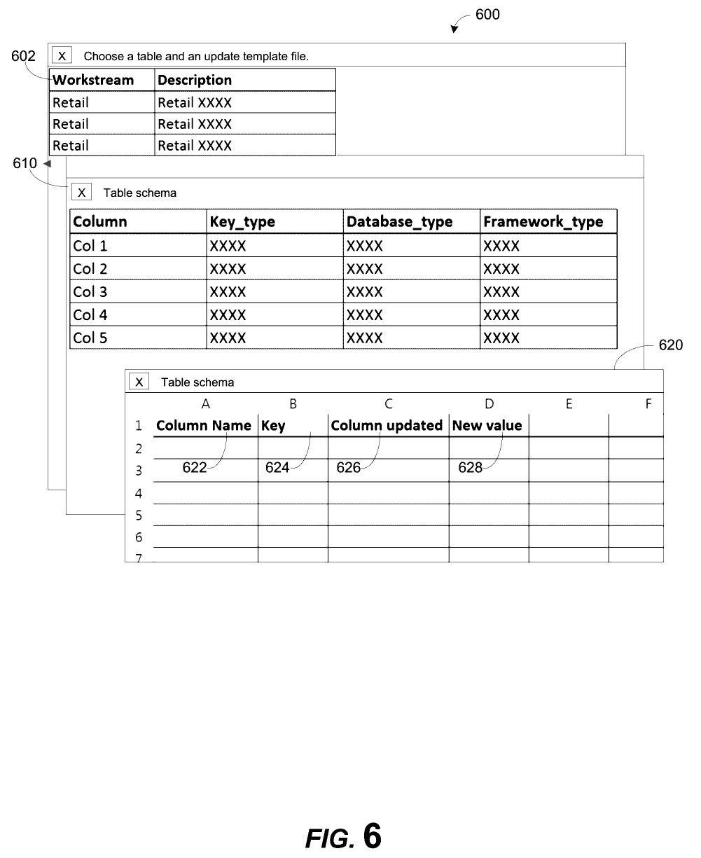

The CSV file is a template that is created and/or saved within the manual adjustment application. The user 4 can download a template table from the table in the database that is to be updated. One embodiment the CSV interface 600 is illustrated in FIG. 6. The CSV interface 6 may include a workstream column 602 identifying the unit for which the resource data relates; a description column 604 describing for what the table is used; and an identification column 606 providing a name for the table. Once a table is selected, the CSV interface 600 may display a sub-interface 610 and/or provide a new interface illustrating the selected table. Thereafter, the user 4 may request to download a sample template 620 that the user may edit, populate, or the like. The template may include the column being updated 622 and the key 624 associated with the column in order to identify the location of the resource data in the database. One benefit of the downloading the sample template is to confirm that the correct column headers in the resource data are present. The user 4 may then populate the updated column 626 being adjusted and the associated value 628 that should replace the original resource data. When the sample template is updated the manual adjustment application will create the CSV file used to make the adjustment, and the user 4 may save the adjustment for approval and future use.

In some embodiments, the user 4 may also edit adjustment sets previously created through the SQL interface 500 and/or the CSV interfaces 600. As such, the manual adjustment application can be utilized to update the resource data before the resource data is used in creating the reports.

FIG. 3 illustrates in block 350 that the user 4 may utilize a submission application to upload external resource data in to the data storage system 30. This may include uploading the data through a particular work steam, determining variance calculations (e.g., analyze the current data vs. the previous data), data attestation (e.g., the user 4 may have to confirm the authenticity of the data and the data may require approval), sending and receiving approval, or the like. The system will update the appropriate tables within the data storage systems 30 based on the data submitted by the user 4 through the submission application.

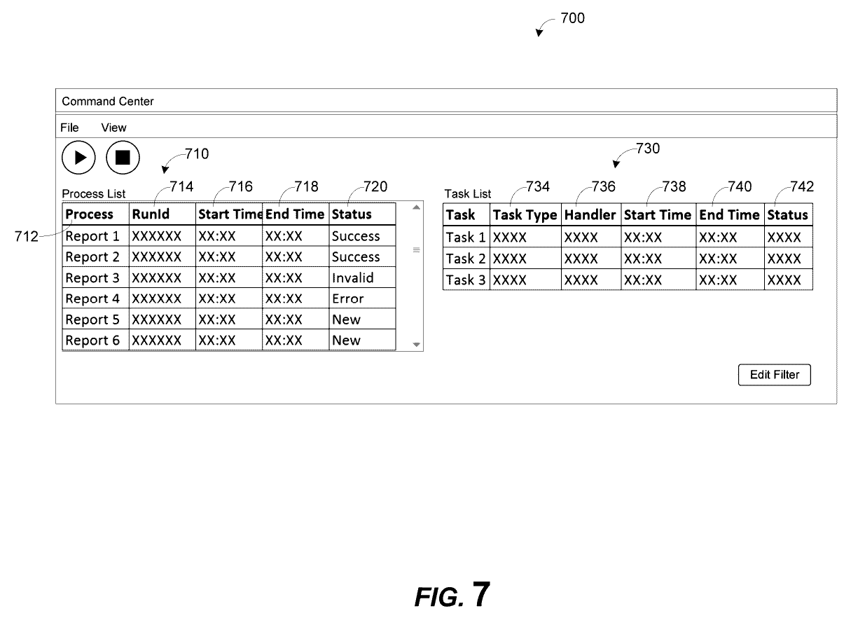

As illustrated in block 360, after the reporting applications are used to create the report, reference data manager is used to manage the reference data used by the calculators, the manual adjustment application is utilized to adjust the resource data, and/or the submission tool is used to upload additional resource data, then the reports may be run and/or controlled through a control center interface. One embodiment of the control center interface 700 is illustrated in FIG. 7. The control center interface 700 serves as a single source of execution and monitoring for the resource usage and availability application 17 run time processes and tasks for the reports. The control center interface 700 may be utilized for running and monitoring data movement and calculation processes that create the source data for reporting. The control center interface 700 may have a process section 710 and a task section 730. The process section 710 displays the run configurations while the task section 730 illustrates the tasks associated with the selected run configurations. The process section 710 may include a process list 712 which displays the run configurations for a report; a run id list 714 for providing a unique identifier for each run configuration of the report; a start time list 716 for indicating when the process started; an end time list 718 when the entire process is completed; and a status list 720 indicating the status of the report. The task section 730 may include a task list 732 illustrating the tasks associated with the selected run configuration for the report; a task type list 734 illustrating the task type and the system performing the task (e.g., data storage systems 30, framework systems 40, data transmission systems 50, and/or reporting systems 60, or the like); a handler 736 providing a reference to the module handling the task; a task start time list 738 indicating when the process started; end time list 740 indicating when the task ended; and/or a status list 742 indicating if the task is new, started, a success, or an error. The user 4 may start, stop, add, delete, and/or monitor the status of the reports run, being run, or set up for running. The user 4 only has to select the report and in order to take an action with respect to the report (e.g., start, stop, or the like).

Once the reports are run, the reports may be sent to the appropriate users, entities, or the like as outlined when creating the reports through the reporting application, and/or through other applications within the resource usage and availability application 17, as illustrated in block 570 in FIG. 3.

As will be appreciated by one of skill in the art in view of this disclosure, embodiments of the invention may be embodied as an apparatus (e.g., a system, computer program product, and/or other device), a method, or a combination of the foregoing. Accordingly, embodiments of the invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the invention may be written in an object oriented, scripted or unscripted programming language such as Java, Pearl, Python, Smalltalk, C++ or the like. However, the computer program code/computer-readable instructions for carrying out operations of the invention may also be written in conventional procedural programming languages, such as the “C” programming language or similar programming languages.

Embodiments of the invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A system for monitoring and analyzing resource usage and availability for providing reports regarding the resource usage and availability, the system comprising:
one or more memory devices having computer readable code store thereon; and
one or more processing devices operatively coupled to the one or more memory devices, wherein the one or more processing devices are configured to execute the computer readable code to:
receive a request from a user to create a report for the resource usage and availability for an activity, wherein the report is created by the user by utilizing a logical data model and a schema;
receive a request from the user to utilize a reference data manger application to select the reference data utilized to create the report, wherein the reference data includes standardized data used by calculations to transform resource data for the reports;
receive a request from the user to utilize a manual adjustment application to adjust the resource data, wherein the resource data includes the data for forecasting, for scenarios, or for compliance regarding the resource usage and availability;
receive a request from the user to access a command and control center application to monitor reports, wherein the user may start, stop, or check the status of the reports being run;
receive a request from the user to run the report;
utilize the logical data model and the schema, the reference data, and the resource data to transform the reference data and the resource data to create the report; and
provide the report to the user regarding the activity on a user computer system.

2. The system of claim 1, wherein the logical data model comprises logical object tables and logical hierarchies, wherein the logical object tables correspond to physical stored tables of resource data or reference data, and wherein the logical hierarchies group attributes in the tables to reflect relationships and provide convenient drilling paths for the report.

3. The system of claim 1, wherein the logical data model comprises the attributes, facts, and transformations; wherein the attributes represent qualitative information, provide context, and define the aggregation level of calculations on the report; wherein the facts are quantitative information displayed on the report, and are determined from one or more fields in the resource data; and the transformations allow the user to apply an attribute offset for fact comparison purposes.

4. The system of claim 1, wherein the schema comprises a map to the resource data or the reference data.

5. The system of claim 1, wherein the report is further based on a template providing a structure of how the report will be presented, wherein the template is populated with report objects including the attributes, metrics, and filters; wherein the attributes represent qualitative information, provide context, and define the aggregation level of calculations on the report; wherein the metrics include numbers that the user wants to include in the report and are associated with the attributes; and the filters include view filters and report filters.

6. The system of claim 1, wherein the manual adjustment application is used by the user to adjust resource data using a structured query language (SQL) query or a comma separated value (CSV) file.

7. The system of claim 1, wherein the one or more processing devices are configured to execute the computer readable code to:
receive a request from the user to utilize a submission framework to add additional data to the resource data; and
wherein the report is further based on the additional data added to the resource data.

8. A computer implemented method for monitoring and analyzing resource usage and availability for providing reports regarding the resource usage and availability, the method comprising:
receiving, by one or more processing components, a request from a user to create a report for the resource usage and availability for an activity, wherein the report is created by the user by utilizing a logical data model and a schema;
receiving, by the one or more processing components, a request from the user to utilize a reference data manger application to select the reference data utilized to create the report, wherein the reference data includes standardized data used by calculations to transform resource data for the reports;
receiving, by the one or more processing components, a request from the user to utilize a manual adjustment application to adjust the resource data, wherein the resource data includes the data for forecasting, for scenarios, or for compliance regarding the resource usage and availability;
receiving, by the one or more processing components, a request from the user to access a command and control center application to monitor reports, wherein the user may start, stop, or check the status of the reports being run;
receiving, by the one or more processing components, a request from the user to run the report;
utilizing, by the one or more processing components, the logical data model and the schema, the reference data, and the resource data to transform the reference data and the resource data to create the report; and
providing, by the one or more processing components, the report to the user regarding the activity on a user computer system.

9. The method of claim 8, wherein the logical data model comprises logical object tables and logical hierarchies, wherein the logical object tables correspond to physical stored tables of resource data or reference data, and wherein the logical hierarchies group attributes in the tables to reflect relationships and provide convenient drilling paths for the report.

10. The method of claim 8, wherein the logical data model comprises the attributes, facts, and transformations; wherein the attributes represent qualitative information, provide context, and define the aggregation level of calculations on the report; wherein the facts are quantitative information displayed on the report, and are determined from one or more fields in the resource data; and the transformations allow the user to apply an attribute offset for fact comparison purposes.

11. The method of claim 8, wherein the schema comprises a map to the resource data or the reference data.

12. The method of claim 8, wherein the report is further based on a template providing a structure of how the report will be presented, wherein the template is populated with report objects including the attributes, metrics, and filters; wherein the attributes represent qualitative information, provide context, and define the aggregation level of calculations on the report; wherein the metrics include numbers that the user wants to include in the report and are associated with the attributes; and the filters include view filters and report filters.

13. The method of claim 8, wherein the manual adjustment application is used by the user to adjust resource data using a structured query language (SQL) query or a comma separated value (CSV) file.

14. The method of claim 8, further comprising:
receiving, by the one or more processing devices, a request from the user to utilize a submission framework to add additional data to the resource data; and
wherein the report is further based on the additional data added to the resource data.

15. A computer program product for monitoring and analyzing resource usage and availability for providing reports regarding the resource usage and availability, the computer program product comprising at least one non-transitory computer-readable medium having computer-readable program code portions embodied therein, the computer-readable program code portions comprising:
an executable portion configured to receive a request from a user to create a report for the resource usage and availability for an activity, wherein the report is created by the user by utilizing a logical data model and a schema;
an executable portion configured to receive a request from the user to utilize a reference data manger application to select the reference data utilized to create the report, wherein the reference data includes standardized data used by calculations to transform resource data for the reports;
an executable portion configured to receive a request from the user to utilize a manual adjustment application to adjust the resource data, wherein the resource data includes the data for forecasting, for scenarios, or for compliance regarding the resource usage and availability;
an executable portion configured to receive a request from the user to access a command and control center application to monitor reports, wherein the user may start, stop, or check the status of the reports being run;
an executable portion configured to receive a request from the user to run the report;
an executable portion configured to utilize the logical data model and the schema, the reference data, and the resource data to transform the reference data and the resource data to create the report; and
an executable portion configured to provide the report to the user regarding the activity on a user computer system.

16. The computer program product of claim 15, wherein the logical data model comprises logical object tables and logical hierarchies, wherein the logical object tables correspond to physical stored tables of resource data or reference data, and wherein the logical hierarchies group attributes in the tables to reflect relationships and provide convenient drilling paths for the report.

17. The computer program product of claim 15, wherein the logical data model comprises the attributes, facts, and transformations; wherein the attributes represent qualitative information, provide context, and define the aggregation level of calculations on the report; wherein the facts are quantitative information displayed on the report, and are determined from one or more fields in the resource data; and the transformations allow the user to apply an attribute offset for fact comparison purposes.

18. The computer program product of claim 15, wherein the schema comprises a map to the resource data or the reference data.

19. The computer program product of claim 15, wherein the report is further based on a template providing a structure of how the report will be presented, wherein the template is populated with report objects including the attributes, metrics, and filters; wherein the attributes represent qualitative information, provide context, and define the aggregation level of calculations on the report; wherein the metrics include numbers that the user wants to include in the report and are associated with the attributes; and the filters include view filters and report filters.

20. The computer program product of claim 15, wherein the manual adjustment application is used by the user to adjust resource data using a structured query language (SQL) query or a comma separated value (CSV) file.
